(19) United States
(12) Patent Application Publication
(10) Pub. No.: US 2005/0125253 A1
(43) Pub. Date: Jun. 9, 2005

(54) System and method for using medication and medical condition information in automated insurance underwriting

(75) Inventors: Piero Patrone Bonissone, Schenectady, NY (US); Kareem Sherif Aggour, Niskayuna, NY (US); Jo Ann Hurley-Tuel, Novato, CA (US); Rick William Storms, San Anselmo, CA (US)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(73) Assignee: GE Financial Assurance Holdings, Inc.

(21) Appl. No.: 10/726,618

(22) Filed: Dec. 4, 2003

(51) Int. Cl. G06F 17/60

(52) U.S. Cl. 705/2; 705/4

(57) ABSTRACT

A system and method is provided for using medication and medical impairment information in automated insurance underwriting. A method in accordance with embodiments of the invention may comprise the steps of identifying medication information provided by an applicant, identifying medical condition information provided by the applicant, assessing a consistency between the medication information and the medical condition information, and making at least one insurance underwriting decision based on the consistency between the medication information and the medical condition information.

### BACKGROUND OF THE INVENTION

The present invention relates to the field of insurance underwriting. More particularly, the present invention relates to the use of medication and medical impairment information in automated insurance underwriting.

In the process of insurance underwriting, a given application for insurance (also referred to as an “insurance application”) may be compared against a plurality of underwriting standards set by an insurance company. The insurance application may be classified into one of a plurality of risk categories available for a type of insurance coverage requested by an applicant. The risk categories then affect a premium paid by the applicant, e.g., the higher the risk category, the higher the premium. A decision to accept or reject the application for insurance may also be part of this risk classification, as risks above a certain tolerance level set by the insurance company may simply be rejected.

For medical insurance, long term care insurance, life insurance and any other insurance products for which the applicant's health is an important risk factor, part of the application process includes listing any medical impairment(s) from which the applicant suffers. Another portion of the application includes specifying what prescription medications the applicant currently takes. An applicant's impairments, and whether or not they are being treated, nay affect the risk category into which the applicant is placed. Therefore, to ensure accurate placement of the application into its appropriate risk category, it is important to identify all of the impairments that an applicant has, and to determine whether or not those impairments are being treated.

However, the medication and medical impairment information provided by an applicant for the type of insurance products mentioned above may not always be accurate or consistent. For example, some applicants may make unintentional mistakes when submitting this information with the application. To avoid higher premiums or possible rejection of coverage, some applicants may intentionally withhold key information about the medical impairments they are suffering from or the medications they are taking. Without realizing the inaccuracies or inconsistencies in the insurance applications, the insuring company may assume a greater risk than it is prepared for.

Conventional methods for dealing with applicants' medication and medical impairment information only use this information directly to assess related insurance risks. They do not automatically discover the inconsistencies in the applications and therefore may result in erroneous placement of the applications in the risk categories.

Other drawbacks may also exist in known techniques.

### BRIEF SUMMARY OF THE INVENTION

Accordingly, the present invention is directed to a system and method for using medication and medical impairment information in automated insurance underwriting that overcome these and other drawbacks of present systems and methods.

In accordance with the purposes of the embodiments of the invention, as embodied and broadly described herein, a method for using medication and medical condition information in automated insurance underwriting comprises the steps of identifying medication information provided by an applicant, identifying medical condition information provided by the applicant, assessing a consistency between the medication information and the medical condition information, and making at least one insurance underwriting decision based on the consistency between the medication information and the medical condition information.

In another aspect, a computer readable medium having code for causing a processor to use medication and medical condition information in automated insurance underwriting comprises code adapted to identify medication information provided by an applicant, code adapted to identify medical condition information provided by the applicant, code adapted to assess a consistency between the medication information and the medical condition information, and code adapted to make at least one insurance underwriting decision based on the consistency between the medication information and the medical condition information.

In yet another aspect, a system for using medication and medical condition information in automated insurance underwriting comprises a first identification module for identifying medication information provided by an applicant, a second identification module for identifying medical condition information provided by the applicant, an assessment module for assessing a consistency between the medication information and the medical condition information, and an insurance module for making at least one insurance underwriting decision based on the consistency between the medication information and the medical condition information.

In still another aspect, a system for using medication and medical condition information in automated insurance underwriting comprises means for identifying medication information provided by an applicant, means for identifying medical condition information provided by the applicant, means for assessing a consistency between the medication information and the medical condition information, and means for making at least one insurance underwriting decision based on the consistency between the medication information and the medical condition information.

In a further aspect, a method for using medication and medical condition information in automated insurance underwriting comprises the steps of identifying medication information provided by an applicant, identifying medical condition information provided by the applicant, assessing a consistency between the medication information and the medical condition information, making at least one insurance underwriting decision based on the consistency between the medication information and the medical condition information. The method further comprises generating a list of possibly treated conditions based at least in part on the medication information provided by the applicant, and comparing the list with the medical condition information provided by the applicant. The method further comprises querying a medical knowledge database, the database comprises information associated with a plurality of medications, a plurality of medical conditions, and treatment associations between the plurality of medications and the plurality of medical conditions.

It is understood that both the foregoing general description and the following detailed description are exemplary and explanatory and are intended to provide further explanation of the invention as claimed.

### BRIEF DESCRIPTION OF THE DRAWINGS

The accompanying drawings, which are incorporated in and constitute a part of this specification, illustrate an embodiment of the invention and, together with the description, serve to explain the principles of the invention.

FIG. 1 is a flow chart illustrating a method for using medication and medical impairment information in automated insurance underwriting, according to an exemplary embodiment of the present invention.

FIG. 2 is a diagram illustrating a portion of the contents of a medical knowledge database according to an exemplary embodiment of the present invention.

FIG. 3 shows one example of medication and medical impairment information evaluated according to an embodiment of the present invention.

FIG. 4 shows another example of medication and medical impairment information evaluated according to an embodiment of the present invention.

FIG. 5 shows yet another example of medication and medical impairment information evaluated according to an embodiment of the present invention.

FIG. 6 is a schematic representation of a system for using medication and medical impairment information in automated insurance underwriting, according to an embodiment of the present invention.

FIG. 7 is a screen shot of a user interface from a system for using medication and medical impairment information in automated insurance underwriting according to an exemplary embodiment of the present invention.

### DETAILED DESCRIPTION OF THE INVENTION

A system and method for using medication and medical condition information in automated insurance underwriting are described.

One technical effect of the invention is to provide a system and method for using medication and medical condition information in automated insurance underwriting, as set forth in the Brief Summary of the Invention, above and as more fully described here in the Detailed Description of the Invention.

Reference will now be made in detail to the present embodiments of the invention, examples of which are illustrated in the accompanying drawings.

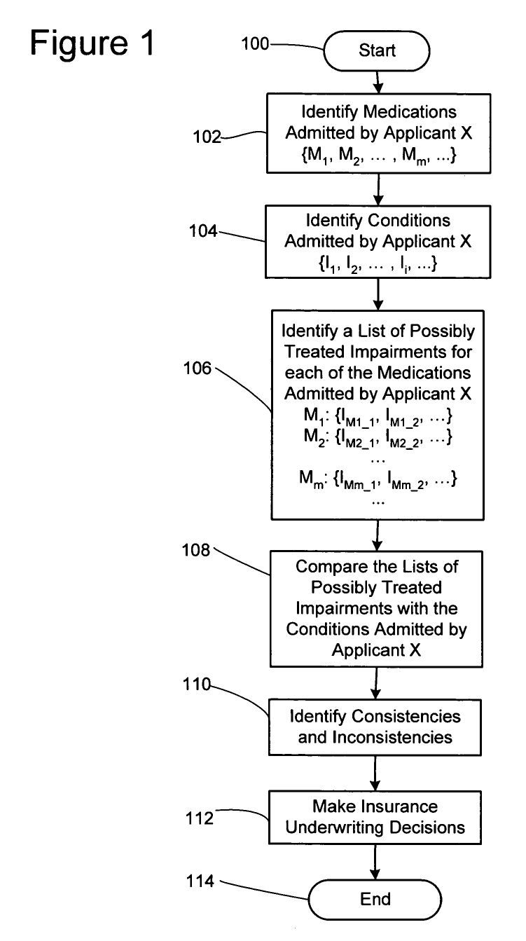

FIG. 1 is a flow chart illustrating a method for using medication and medical impairment information in automated insurance underwriting, according to an exemplary embodiment of the present invention.

The method starts at step 100. At step 102, an insurance application submitted by an individual (“Applicant X”) is examined and analyzed. The insurance application may include name, date of birth, disease history, the health history of relatives, operations, etc. Medications, if any, that the applicant admits to be taking, are also identified. According to embodiments of the invention, the insurance application may be submitted in a number of manners. For example, it may be submitted manually on paper-based documents. Or it may be prepared on a computer and sent electronically via a computer network to the insurance company. Other methods to prepare and submit an insurance application may also be used. When an insurance application is received, it is examined and analyzed, and its content information is extracted and standardized for the automated underwriting process. If Applicant X admits to be taking any medications, these medications may be identified based on the information provided by the applicant. The information may include the names of the medications, the amount taken per dosage, the frequency of dosage, the time period for which each medication is taken, etc. It is understood that Applicant X may admit to be taking a plurality of medications, one medication, or no medications. For the purpose of this specific illustration, it is assumed that Applicant X admits to a plurality of medications {M₁, M₂, . . . , Mₘ, . . . }, where M₁ represents the first medication admitted by Applicant X, M₂ represents the second medication, and so on, as Mₘ represents the m^{th} medication where “m” is an integer.

At step 104, medical conditions that Applicant X admits to having are identified based on the information provided in the insurance application. This information may include the name of the medical condition, the cause, the severity and the duration of each condition. It is possible that Applicant X may admit to having a plurality of medical conditions, one medical condition, or none at all. Again, for the purpose of this specific illustration, it is assumed that Applicant X admits to a plurality of medical conditions {I₁, I₂, . . . , Iᵢ, . . . }, where I₁ represents the first condition admitted by Applicant X, I₂ represents the second condition, and so on, as Is represents the i^{th} impairment where “i” is an integer. If Applicant X admits to no impairment at all, the collection {I₁, I₂, . . . , Iᵢ, . . . } may turn out to be empty.

At step 106, a list of medical conditions is identified, as “Possibly Treated Conditions,” to be associated with each of the medications admitted by Applicant X, where each of the identified medical conditions may be treated, at least partially, by its associated medication. For example, medical conditions {I_{M1}_{_{—}}₁, I_{M1}_{_{—}}₂, . . . } may be identified to be associated with medication M₁, where I_{M1}_{_{—}}₁ represents a first condition that may be treated, at least partially, by medication M₁, I_{MI}_{_{—}}₂ represents a second condition that may be treated, at least partially, by medication M₁, and so on. Similarly, a plurality of conditions {I_{M2}_{_{—}}₁, I_{M2}_{_{—}}₂, . . . } may be identified to be associated with M₂, {I_{Mm}_{_{—}}₁, I_{Mm}_{_{—}}₂, . . . } with Mₘ, and so on.

For an example, if the prescription medication Diazepam is among those admitted by the applicant, a list of medical conditions that include anxiety, muscle spasms, insomnia, and epilepsy may be identified to be associated with Diazepam as Possibly Treated Conditions.

According to an exemplary embodiment of the invention, lists of Possibly Treated Conditions may be identified by use of a medical knowledge database. The medical knowledge database may maintain a list of medications, a list of medical conditions, and established associations between each of the listed medications and each of the listed conditions. According to an embodiment of the invention, these established associations may help to identify, for each of the listed medications, what known medical conditions it can treat, and for each of the listed conditions, what medications it can be treated with. It is also possible that there may exist one or more important conditions for which there are no known medications for treatment.

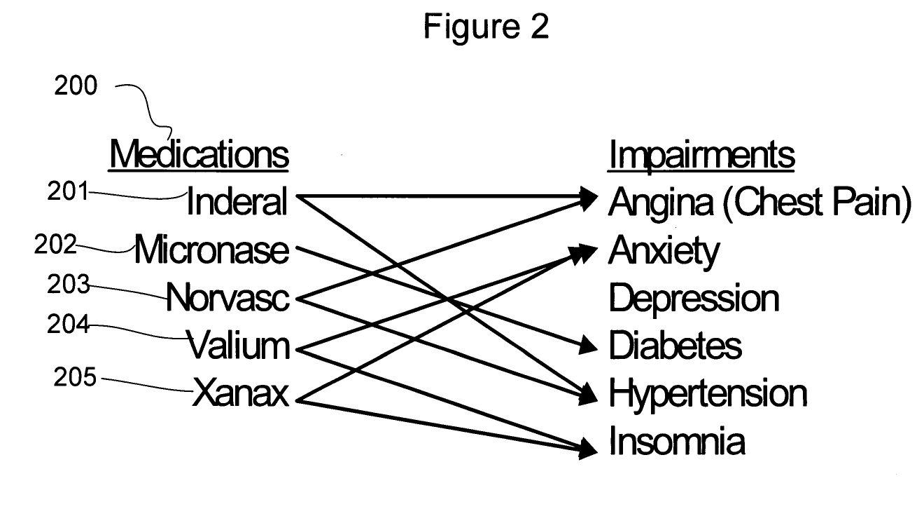

FIG. 2 is a graph illustrating a portion of the contents of a medical knowledge database according to an exemplary embodiment of the present invention. In the “Medications” column 200, a number of medications, such as Inderal® 201, Micronase® 202, Norvasc® 203, Valium® 204, and Xanax® 205, are listed. In the “Conditions” column, a number of medical conditions, such as angina (chest-pain), Anxiety, Depression, Diabetes, Hypertension and Insomnia, are listed. The arrows indicate the associations between the medications and the conditions. For example, an arrow that originates from a medication and points toward a condition indicates that this medication may be prescribed to treat this condition. For a more specific example, the arrow linking Micronase® and Diabetes on the graph indicates that Micronase® may be prescribed to treat or assist in the treatment of diabetes. According to embodiments of the invention, there may exist more than one condition for whose treatment a certain medication may be relevant. For example, Norvasc® may be prescribed to treat not only angina but also hypertension, as illustrated in FIG. 2. On the other hand, there may also exist more than one medication that may be useful for treatment of one certain medical condition. For another example, insomnia may be treated by either Valium® or Xanax®. According to an embodiment of the invention, one way to generate a list of Possibly Treated Conditions for a particular medication is to identify, in the medical knowledge database, all the conditions that may be treated by this medication.

According to exemplary embodiments of the invention, the medical knowledge database may be a prescription medication database or a combination of the like, such as the medication databases created and maintained by Micro-Medex and First Data Bank. According to embodiments of the invention, the medication list, the condition list, and the associations between the medications and conditions may be updated over time to include new conditions, medications and coverage relationships.

At step 108, the lists of Possibly Treated Conditions for the medications admitted by Applicant X are compared with the list of conditions that Applicant X admits to be suffering from. By way of example, the list of Possibly Treated Conditions {I_{M1}_{_{—}}₁, I_{M1}_{_{—}}₂, . . . } for medication M₁ may be compared with Applicant X's condition list {I₁, I₂, . . . , Iᵢ, . . . }. Also, {I_{M2}_{_{—}}₁, I_{M2}_{_{—}}₂, . . . } may be compared with {I₁, I₂, . . . , Iᵢ, . . . }, {I_{Mm}_{_{—}}₁, I_{Mm}_{_{—}}₂, . . . } with {I₁, I₂, . . . , Iᵢ, . . . }, and so on. Alternatively, the lists {I_{M1}_{_{—}}₁, I_{M1}_{_{—}}₂, }, {I_{M2}_{_{—}}₁, I_{M2}_{_{—}}₂, }, {I_{Mm}_{_{—}}₁, I_{Mm}_{_{—}}₂, } and so on, may be combined and then compared with Applicant X's condition list {I₁, I₂, . . . , Iᵢ, . . . }. Other approaches to achieve the same effect may also exist.

Based on the comparison results from step 108, three possible scenarios may be identified and the consistency of Applicant X's insurance application may be evaluated accordingly at step 110.

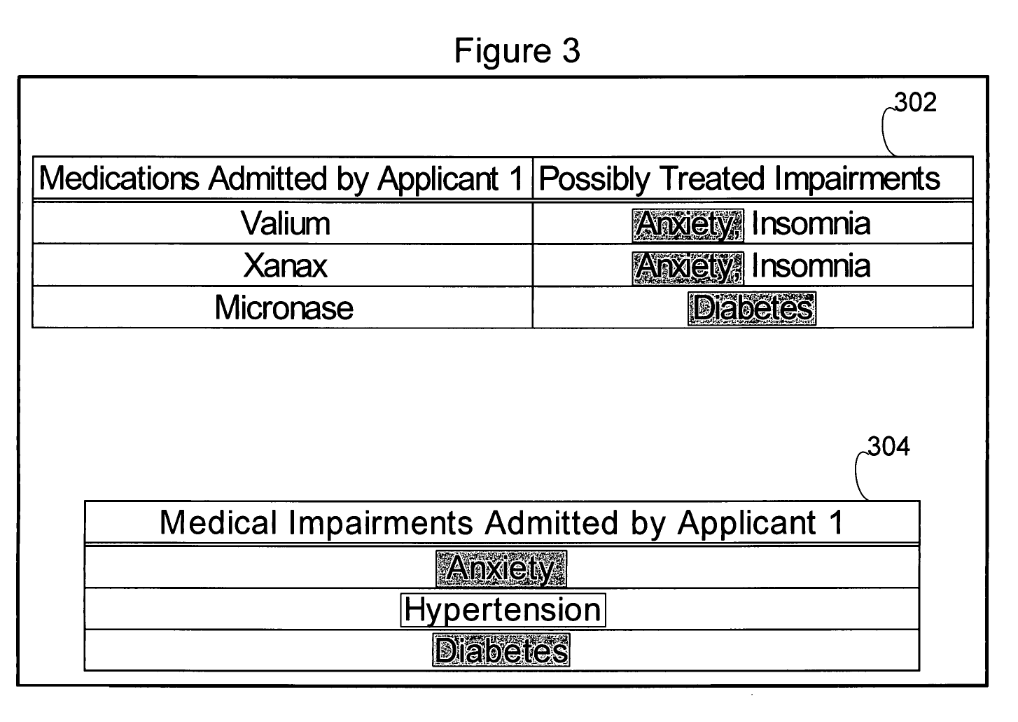

In Scenario 1, a condition admitted by the applicant is not found in any of the lists of Possibly Treated Conditions. This finding of inconsistency may suggest that the applicant is not receiving proper medical attention for this particular condition. One example of this scenario is illustrated in FIG. 3, according to an embodiment of the present invention. In FIG. 3, Table 302 shows the medications, Valium®, Xanax® and Micronase® that Applicant 1 admits to be taking, and the Possibly Treated Conditions associated with each of the admitted medications. Table 304 lists the medical conditions, Anxiety, Hypertension and Diabetes that Applicant 1 admits to be suffering from. Anxiety and Diabetes can be found among the Possibly Treated Conditions in Table 302. However, Hypertension is not found among those conditions listed in Table 302. This discovery indicates that Applicant 1 is not taking any medication to treat Hypertension. Another example that fits Scenario 1 is when the applicant admits to be suffering from one or more medical impairments but admits to be taking no medications at all.

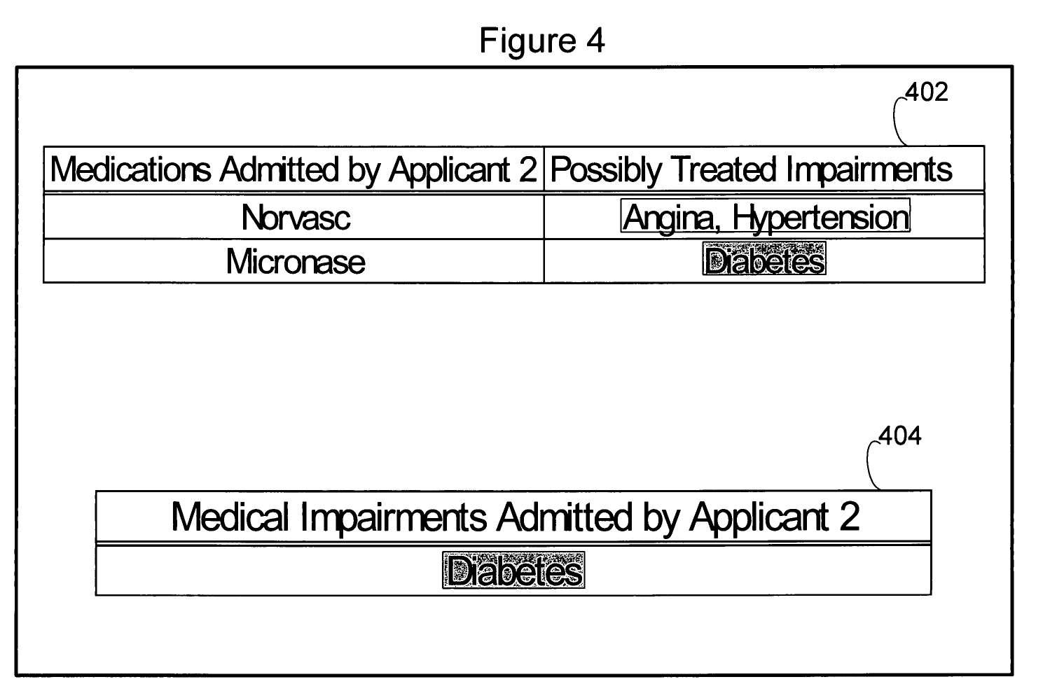

In Scenario 2, none of the Possibly Treated Conditions for a medication admitted by the applicant is found among the conditions admitted by the applicant. This finding of inconsistency suggests that the applicant may be suffering from at least one of the Possibly Treated Conditions for this particular medication. One example of this scenario is illustrated in FIG. 4, according to an embodiment of the present invention. In FIG. 4, Table 402 shows the medications, Norvasc® and Micronase® that Applicant 2 admits to be taking, and the Possibly Treated Conditions associated with each of the admitted medications. Table 404 lists the medical condition, Diabetes that Applicant 2 admits to be suffering from. Since neither Angina nor Hypertension, which are covered by the medication Norvasc®, can be found in Table 404, and Norvasc® is known to be unrelated to the treatment of Diabetes, it may be suspected that Applicant 2 is suffering from at least one cardiovascular disease such as angina or hypertension, in addition to diabetes. Another example that fits Scenario 2 is when the applicant admits to be taking one or more medications but admits to be suffering from no impairments at all.

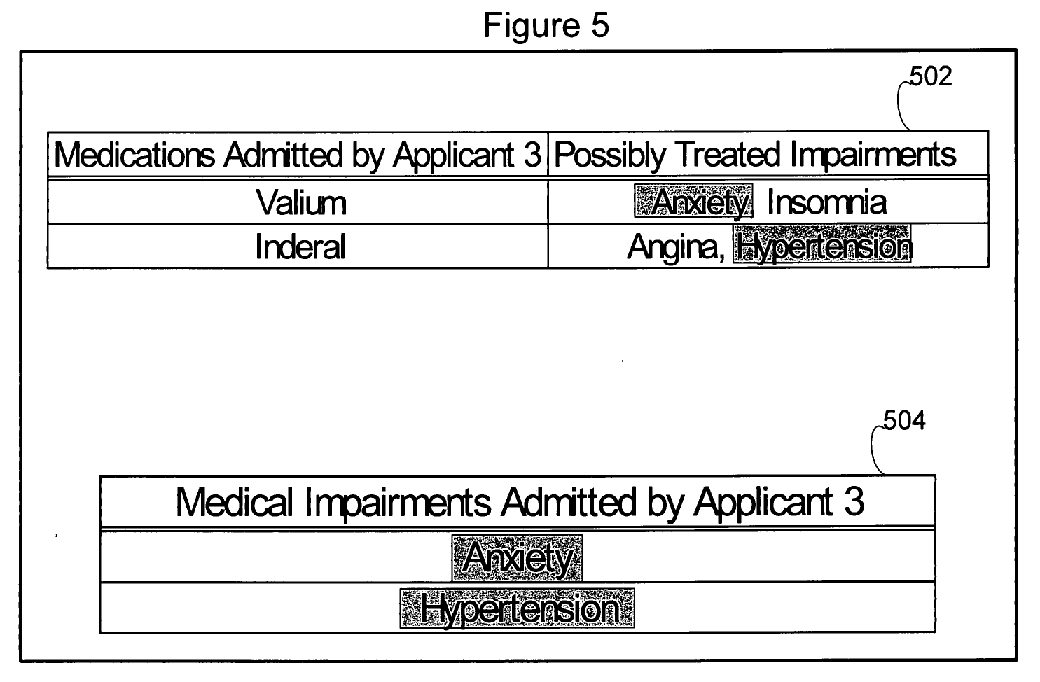

In Scenario 3, every condition admitted by the applicant is found among the lists of Possibly Treated Conditions. This finding indicates that the medication and medical condition information provided by the applicant may be consistent. One example of this scenario is illustrated in FIG. 5, according to an embodiment of the present invention. In FIG. 5, Table 502 shows the medications, Valium® and Inderal® that Applicant 3 admits to be taking, and the Possibly Treated Conditions associated with each of the admitted medications. Table 504 lists the medical conditions, Anxiety and Hypertension that Applicant 3 admits to be suffering from. Since both Anxiety and Hypertension can be found among the Possibly Treated Conditions listed in Table 502, the medication and medical condition information provided by Applicant 3 may be deemed consistent.

According to an embodiment of the invention, scenarios 1 and 2 may co-exist for one applicant. That is, an applicant may admit to be taking at least one medication that does not treat any of his/her admitted conditions, meanwhile there may exist at least one admitted condition that is not treatable by any of his/her admitted medications. It may also be true that there are neither medical conditions nor medications admitted in the insurance application, in which case the application may be considered consistent.

At step 112, insurance underwriting decisions are made based on the findings made at step 110. Depending on whether the medication and medical condition information provided by Applicant X is consistent, the placement of Applicant X's insurance application into an appropriate risk category may be adjusted.

For an example, if, as described in Scenario 1, an applicant is found to be suffering from a condition that is not being treated with any medication, this applicant may pose a greater risk to the insuring company. In the case of medical insurance, the insurance issuer may be more likely to receive future claims related to this particular condition from this applicant if his/her application is approved. Accordingly, this applicant's application may be placed in a category that reflects this potential risk. Furthermore, decisions may be made to either charge the applicant a higher premium or to simply reject his/her application, based on the risk category into which the application is placed. Further investigation may also be an option.

According to another example, if, as described in the second scenario, an applicant is suffering from an condition that he/she did not explicitly identify on the insurance application, the applicant may be less healthy than he/she claims to be. This may also represent a serious risk to the insuring company. In view of this scenario, the insurer may decide to place this applicant's application into a higher risk category. More information may be requested from the applicant and investigation may be ordered. Other decisions may also be made based on this finding of inconsistency.

According to a further example, if, as described in the third scenario, the condition information provided by an applicant is consistent with his/her medication information, the application may be placed into its appropriate risk category and further insurance underwriting decisions may be made, with a high level of confidence.

The method ends at step 114.

According to an embodiment of the invention, a computer-usable and writeable medium having a plurality of computer readable program code stored therein may be provided for practicing the process of the present invention described above. The process and system of the present invention may be implemented within a variety of operating systems, such as a Windows™ operating system, various versions of a Unix-based operating system (e.g., a Hewlett Packard™, a Sun™, or a Linux version of a Unix-based operating system), or various versions of an AS/400-based operating system. For example, the computer-usable and writeable medium may be comprised of a CD ROM, a floppy disk, a hard disk, or any other computer-usable medium.

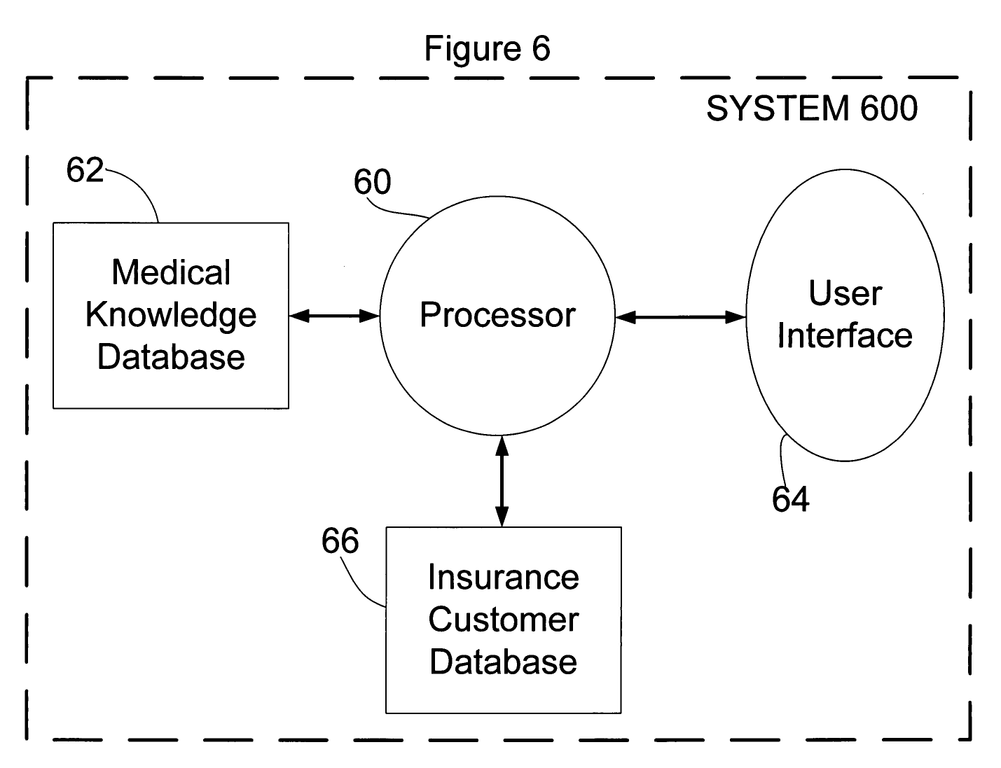

FIG. 6 is a schematic representation of a system (“System 600”) for using medication and medical condition information in automated insurance underwriting, according to an exemplary embodiment of the present invention. The system comprises Processor 60, Medical Knowledge Database 62, Insurance Customer Database 66, and User Interface 64.

According to embodiments of the invention, the System 600 may be implemented on computer(s) or a computer-based network. The Processor 60 may be a central processing unit (CPU) or a computer capable of data manipulation, logic operation and mathematical calculation. According to an embodiment of the invention, the Processor 60 may be a standard computer comprising an input device, an output device, a processor device, and a data storage device. The Medical Knowledge Database 62 may be one or more databases containing at least the information of medications, medical conditions and treatment relationships among the medications and conditions. The Insurance Customer Database 66 may be a plurality of databases containing insurance applications and standardized information extracted from the applications. The User Interface 64 may be a graphical user interface (GUI) serving the purpose of obtaining inputs from and presenting results to a user of the system. According to embodiments of the invention, the User Interface module may be a display, such as a CRT (cathode ray tube), LCD (liquid crystal display) or touch-screen monitor, or a computer terminal, or a personal computer connected to the Processor 60.

By way of example, the operation of System 600 for using medication and medical condition information in automated insurance underwriting will now be described, according to one embodiment of the present invention.

An insurance application to be evaluated according to an embodiment of the invention may be sent to Processor 60 by using User Interface 64. For a specific example, an applicant or an employee of the insuring company may fill out the application on a personal computer and then transmit it to Processor 60 via a network. Alternatively, an insurance application already stored in the Insurance Customer Database may be selected and sent to Processor 60. Next, Processor 60 may examine the application, extract and standardize relevant medication and medical condition information from the application. Based on the standardized information, a list of medications that the applicant admits to be taking may be identified. A list of medical conditions that the applicant admits to be suffering from may also be identified. Then Processor 60 may query Medical Knowledge Database 62 with the medication information provided by the applicant. Through this query, a list of Possibly Treated Conditions for the applicant's admitted medications may be identified. Processor 60 then may compare this list of Possibly Treated Conditions with the applicant's admitted conditions to evaluate the consistency of the application. Based on the comparison and evaluation results, insurance underwriting decisions concerning this particular application may be made. Finally, a report may be generated to describe the evaluation results and subsequent conclusions or decisions. The report may be stored in Insurance Customer Database 66 for future reference and/or sent to User Interface 64 for displaying or printing.

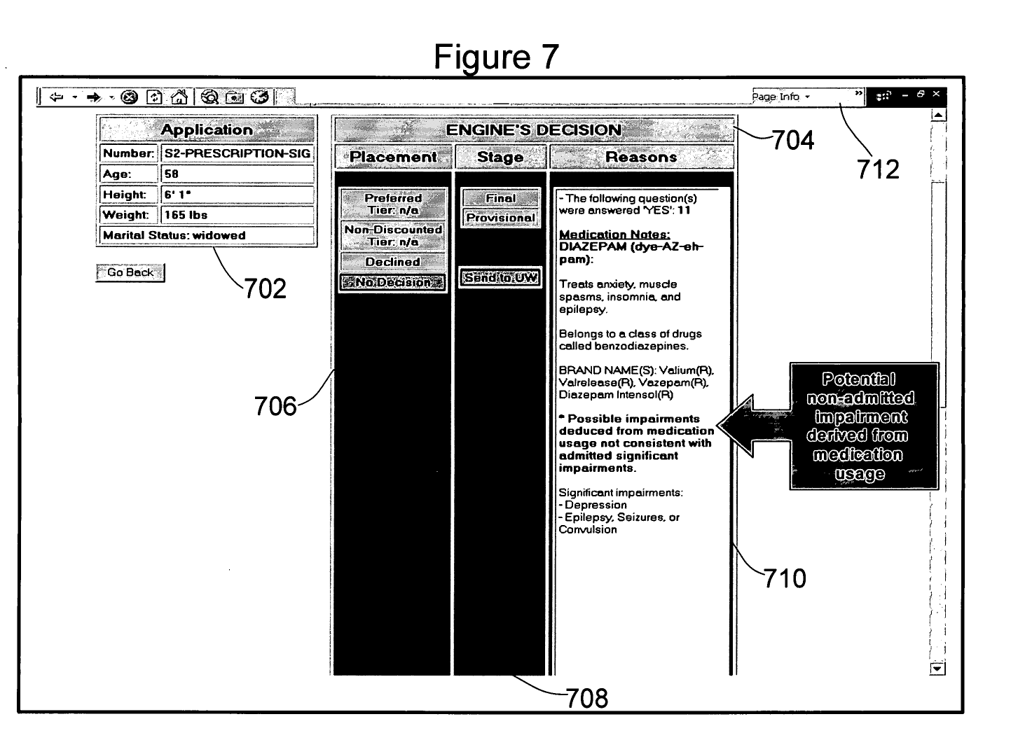

FIG. 7 is a screen shot of a user interface from a system for using medication and medical condition information in automated insurance underwriting according to an exemplary embodiment of the present invention. This user interface has been designed to be used with a web browser. On top of the screen is a navigation bar 712 for the web browser. This particular screen shot captures a report that is generated by the system, according to one embodiment of the invention. Table 702 shows the identification of an application and basic information of the applicant. Table 704, which comprises Column 706, Column 708 and Column 710, displays the evaluation report for this application. In Column 708, a highlighted field displays the processing stage at which the application is being evaluated. Column 706 lists a plurality of decision categories available for this application and the highlighted item indicates a decision suggested by the system. By way of example, a decision may be reached by the system to place an application in the “Preferred Tier” category, if the applicant poses very little risk for the insurer. An application may be placed in the “Declined” category, if the risk to insure the applicant is too much to be acceptable. Or an application may be placed in the “Non-Discounted” category if the risk involved is moderate. For this exemplary case shown in FIG. 7, the system suggests “No Decision” for the reasons that are displayed in Column 710. In general, Column 710 displays the reasons based on which the system reaches the placement decision(s) in Column 706. In this particular example as shown in FIG. 7, Column 710 shows that the applicant answered “YES” to Question 11 on the application admitting to be taking the medication Valium® (also known as Diazepam). Column 710 further shows that since Diazepam treats anxiety, muscle spasms, insomnia, and epilepsy, yet none of these conditions are found among the applicant's admitted significant conditions, the system identifies these conditions as “Possible impairments deduced from medication usage not consistent with admitted significant impairments”. Of these impairments, “Depression” and “Epilepsy, Seizures, or Convulsion” are listed as “Significant impairments.”

The present invention may be characterized as an improvement of the automation of the underwriting decision process for insurance products, such as medical insurance, long term care insurance, life insurance, etc. The methods and systems used to automate this process have been described in the following four U.S. patent applications: (1) “System and Process for Rule-Based Insurance Underwriting Suitable for Use by an Automated System,” Ser. No. 10/171,575, Attorney Docket No. 52493.000161, filed Jun. 17, 2002; (2) “System and Process for Rule-Based Insurance Underwriting Suitable for Use by an Automated System,” Ser. No. 10/173,000, Attorney Docket No. 52493.000160, filed Jun. 18, 2002; (3) “Process and System for Case-Based Insurance Underwriting Suitable for Use by an Automated System,” Ser. No. 10/170,471, Attorney Docket No. 52493.000162, filed Jun. 14, 2002; and (4) “Process and System for Case-Based Insurance Underwriting Suitable for Use by an Automated System,” Ser. No. 10/171,190, Attorney Docket No. 52493.000234, filed Jun. 14, 2002. The contents of these patent applications are incorporated herein by reference in their entirety.

Exemplary embodiments of the present invention complement automated insurance underwriting by providing a system and method for using an applicant's medication and medical impairment information on the application in conjunction with external medical knowledge to automatically evaluate the consistency of the application.

It is also an advantage of exemplary embodiments of the present invention to automatically discover the treatment status of admitted impairments and to identify other possible impairments, which are not admitted, that may affect the outcome of the automated insurance underwriting process.

Additional advantages of the invention will be set forth in part in the description, or may be learned by practice of the invention. The advantages of the invention may be realized and attained by means of instrumentalities and combinations particularly pointed out in the appended claims and are not limited to those described above.

Other embodiments, uses and advantages of the present invention will be apparent to those skilled in the art from consideration of the specification and practice of the invention disclosed herein.

While the foregoing description includes many details and specificities, it is to be understood that these have been included for purposes of explanation only, and are not to be interpreted as limitations of the present invention. Many modifications to the embodiments described above can be made without departing from the spirit and scope of the invention, as is intended to be encompassed by the following claims and their legal equivalents.

1. A method for using medication and medical condition information in automated insurance underwriting, the method comprising the steps of:
identifying medication information provided by an applicant;
identifying medical condition information provided by the applicant;
assessing a consistency between the medication information and the medical condition information; and
making at least one insurance underwriting decision based on the consistency between the medication information and the medical condition information.

2. The method according to claim 1 further comprising:
generating a list of possibly treated conditions based at least in part on the medication information provided by the applicant; and
comparing the list with the medical condition information provided by the applicant.

3. The method according to claim 2 further comprising querying a medical knowledge database, the database comprises information associated with a plurality of medications, a plurality of medical conditions, and treatment associations between the plurality of medications and the plurality of medical conditions.

4. The method according to claim 1, further comprising assigning the applicant to a risk category based on the consistency between the medication information and the medical condition information.

5. A computer readable medium having code for causing a processor to use medication and medical condition information in automated insurance underwriting, the computer readable medium comprising:
code adapted to identify medication information provided by an applicant;
code adapted to identify medical condition information provided by the applicant;
code adapted to assess a consistency between the medication information and the medical condition information; and
code adapted to make at least one insurance underwriting decision based on the consistency between the medication information and the medical condition information.

6. The computer readable medium according to claim 5 further comprising:
code adapted to generate a list of possibly treated conditions based at least in part on the medication information provided by the applicant; and
code adapted to compare the list with the medical condition information provided by the applicant.

7. The computer readable medium according to claim 6 further comprising code adapted to query a medical knowledge database, the database comprises information associated with a plurality of medications, a plurality of medical conditions, and treatment associations between the plurality of medications and the plurality of medical conditions.

8. The computer readable medium according to claim 5, further comprising code adapted to assign the applicant to a risk category based on the consistency between the medication information and the medical condition information.

9. A system for using medication and medical condition information in automated insurance underwriting, the system comprising:
a first identification module for identifying medication information provided by an applicant;
a second identification module for identifying medical condition information provided by the applicant;
an assessment module for assessing a consistency between the medication information and the medical condition information; and
an insurance module for making at least one insurance underwriting decision based on the consistency between the medication information and the medical condition information.

10. The system according to claim 9 further comprising:
a generation module for generating a list of possibly treated conditions based at least in part on the medication information provided by the applicant; and
a comparison module for comparing the list with the medical condition information provided by the applicant.

11. The system according to claim 10 further comprising a query module for querying a medical knowledge database, the database comprises information associated with a plurality of medications, a plurality of medical conditions, and treatment associations between the plurality of medications and the plurality of medical conditions.

12. The system according to claim 9, further comprising an assignment module for assigning the applicant to a risk category based on the consistency between the medication information and the medical condition information.

13. A system for using medication and medical condition information in automated insurance underwriting, the system comprising:
means for identifying medication information provided by an applicant;
means for identifying medical condition information provided by the applicant;
means for assessing a consistency between the medication information and the medical condition information; and
means for making at least one insurance underwriting decision based on the consistency between the medication information and the medical condition information.

14. The system according to claim 13 further comprising:
means for generating a list of possibly treated conditions based at least in part on the medication information provided by the applicant; and
means for comparing the list with the medical condition information provided by the applicant.

15. The system according to claim 14 further comprising means for querying a medical knowledge database, the database comprises information associated with a plurality of medications, a plurality of medical conditions, and treatment associations between the plurality of medications and the plurality of medical conditions.

16. The system according to claim 13, further comprising means for assigning the applicant to a risk category based on the consistency between the medication information and the medical condition information.

17. A method for using medication and medical condition information in automated insurance underwriting, the method comprising the steps of:
identifying medication information provided by an applicant;
identifying medical condition information provided by the applicant;
assessing a consistency between the medication information and the medical condition information;
making at least one insurance underwriting decision based on the consistency between the medication information and the medical condition information;
the method further comprising:
generating a list of possibly treated conditions based at least in part on the medication information provided by the applicant;
comparing the list with the medical condition information provided by the applicant; and
the method further comprising querying a medical knowledge database, the database comprises information associated with a plurality of medications, a plurality of medical conditions, and treatment associations between the plurality of medications and the plurality of medical conditions.

18. The method according to claim 17, further comprising assigning the applicant to a risk category based on the consistency between the medication information and the medical condition information.
